(19) United States
(12) Patent Application Publication
(10) Pub. No.: US 2018/0224520 A1
(43) Pub. Date: Aug. 9, 2018

(54) METHOD AND SYSTEM FOR DETERMINING THE POSITION OF AT LEAST ONE INDUSTRIAL TRUCK IN RELATION TO OTHER INDUSTRIAL TRUCKS

(71) Applicant: Jungheinrich Aktiengesellschaft, Hamburg (DE)

(72) Inventor: Frank Mänken, Henstedt-Ulzburg (DE)

(73) Assignee: Jungheinrich Aktiengesellschaft, Hamburg (DE)

(21) Appl. No.: 15/887,233

(22) Filed: Feb. 2, 2018

(30) Foreign Application Priority Data
Feb. 3, 2017 (DE) 10 2017 102 117.5

(51) Int. Cl. G01S 5/02; G01S 5/04; G05D 1/02; B62D 15/02; G08G 1/16

(52) U.S. Cl. CPC G01S 5/0289; G01S 5/04; G01S 5/0294; G05D 1/0214; G05D 2201/0216; G05D 1/028; B62D 15/0265; G08G 1/161; G05D 1/0223

(57) ABSTRACT

A method is provided for determining a current position of at least one industrial truck having a mobile radio station and positioned in an area having a plurality of stationary radio stations. The method comprises determining vehicle data pertaining to at least one of a vehicle speed and a steering angle of the at least one industrial truck. A position-determining signal is transmitted from the mobile radio station and received by the plurality of stationary radio stations. A position signal is then transmitted from each of the plurality of the stationary radio stations to the mobile radio station. Additional data is appended to at least one of the position-determining signal and the position signal and the current position of the at least one industrial truck is determined from at least three position signals received by the mobile radio station.

### CROSS REFERENCE TO RELATED INVENTION

This application is based upon and claims priority to, under relevant sections of 35 U.S.C. § 119, German Patent Application No. 10 2017 102 117.5, filed Feb. 3, 2017, the entire contents of which are hereby incorporated by reference.

The present invention relates a system and associated method for determining the position of at least one industrial truck in an area having a plurality of stationary radio stations.

Various approaches are known for determining the position of industrial trucks in warehouse areas and other defined environments. It is known to place an RFID transponder in the floor. When an industrial truck drives over the RFID transponder, its position can be communicated. In the field of radio engineering, for example, propagation time measurements and/or angle of incidence measurements to determine the position of the industrial truck relative to immovably installed units are known.

A method and system are known from DE 10 2009 004 854 B4 to determine the position of an industrial truck in which a multi-axis gyro sensor, in particular a gyroscope, is used.

A method for approaching a storage bin with an industrial truck is known from DE 10 2001 018 520 A1, in which the current position of the industrial truck is detected, and a preselected lift height value matching the height of the bin to be approached is set for the current position.

A device for determining the position of an industrial truck is known from DE 10 2009 013 671 A1. In this context, a plurality of light sources are positioned at predefined locations, and a beam clearly identifying the light source is emitted by the light sources. An industrial truck evaluates the incoming beam with the inclusion of the relative angles to each other in order to determine its current position and orientation between three light sources.

The object of the invention is to provide a system and associated method for determining the position of at least one industrial truck in an area having a plurality of stationary radio stations that can determine the current position of the industrial truck with maximum precision.

### BRIEF SUMMARY OF THE INVENTION

In an embodiment, a method is provided for determining a position of at least one industrial truck in an area having a plurality of stationary radio stations. The term “position” in this context comprises the spatial position of the industrial truck, and its orientation in this position. The position of the at least one industrial truck is determined in an area having a plurality of stationary radio stations that transmit a position signal in response to a position-determining signal. The industrial truck is equipped with a mobile radio station. Stationary and mobile radio stations are configured as transmitting and receiving units that are capable of receiving and transmitting radio signals. In an embodiment, vehicle data on the vehicle speed and/or a steering angle in the vehicle are determined. The determined vehicle data describe the actual state or the target state of the vehicle. In an embodiment, a position-determining signal is transmitted by the mobile radio station to the plurality of stationary radio stations. The plurality of stationary radio stations each transmit their positions signal in response to a received position-determining signal. Additional data may be appended to the position-determining signal and/or the position signal. Vehicle data are appended as the additional data to the position-determining signal(i.e., to the signal emitted by the industrial truck) that refer to a vehicle speed and/or a steering angle of the industrial truck. In the position signal as the signal emitted by the stationary radio stations, the additional data comprise position data of industrial trucks. In an embodiment, the mobile radio station receives a plurality of position signals that originate from at least three different stationary radio stations. By using three stationary radio stations, the position of the industrial truck is clearly determined.

In an embodiment, the current position is determined by a Kalman filter with the inclusion of the determined vehicle data. The Kalman filter can work with an expanded state space for the industrial truck that, for example, also comprises its translatory or rotary movement, and thus enables more precise positioning.

The vehicle data may include the current position of the industrial truck. In this manner, the current vehicle positions are also provided by the position-determining signals for the stationary radio stations so that the stationary radio stations can distribute the positions of the industrial trucks to all mobile radio stations by their position signals in the appended additional data.

In an embodiment of the method, the mobile radio station receives information on the current position of other industrial trucks. This information is determined from the received position signals. The position data on participating industrial trucks is exchanged at the same time on the radio channel for determining position. In one possible embodiment, this information is exchanged between the mobile radio stations (i.e., between the respective vehicles).

In an embodiment, information on the current positions of the industrial trucks is transmitted to all industrial trucks proceeding from the stationary radio stations. The stationary radio stations determine the data on the current positions of the industrial trucks from the received position-determining signals to which the current vehicle position is also appended.

In an embodiment of the method, the at least one industrial truck throttles its own speed and/or changes its steering angle when the evaluation of the positions and/or movements of other vehicles indicate a collision hazard. In this embodiment, the industrial truck independently detects from the available data that there is an elevated risk of a collision at its position or in its environment. Consequently, the vehicle speed is then throttled and/or the driving direction is changed. When the vehicle speed is throttled, it is easier for the user of the industrial truck to react to pending collisions and avoid crashes. In the event of a pending collision, a change in the driving direction can also help generate time for an evasive maneuver.

In another embodiment, a plurality of the mobile radio stations answer with a vehicle position signal in response to a position-determining signal so that an industrial truck receiving the vehicle position signal can determine its distance. This distance determining method using transmitted position signals can also be used in addition to the exchange of information on the current position of the other industrial trucks.

A system determines the position of at least one industrial truck in an area having a plurality of stationary radio stations that are configured to transmit a position signal in response to a position-determining signal. Each industrial truck has a mobile radio station that is configured to transmit a position-determining signal and receive position signals. Moreover, an evaluation unit is configured to append additional vehicle data to a position-determining signal to be transmitted and to separate position data on the industrial trucks from received position signals. The evaluation unit is also configured to determine a current vehicle position from at least three position signals. The system comprises an evaluation unit that, on the one hand, determines the current vehicle position from received position signals and, on the other hand, is designed to transmit vehicle data with position-determining signals, and/or to separate position data from received position signals.

In an embodiment, the vehicle data comprise the vehicle speed and/or a steering angle of the industrial truck. In an embodiment, the vehicle data also comprise a current vehicle position. In a further embodiment, the system creates a way to distribute position data to the individual industrial trucks particularly effectively between all the vehicles. On the one hand, the vehicles report their current vehicle position with the vehicle data to the stationary radio stations, whereas at the same time, the stationary radio stations distribute the position data of the industrial trucks by the position signals to the industrial trucks. In this manner, each industrial truck is provided with the position data of the other industrial trucks so that an avoidance of a collision can be carried out in a known manner.

In another embodiment, the evaluation unit is configured to determine position data of other industrial trucks from the received position signals. In this manner, position data on the other industrial trucks is locally available to the individual industrial trucks.

In another embodiment, the mobile radio stations are configured to receive signals on the respective position of another industrial truck from the other mobile radio stations.

The position data on the plurality of industrial trucks is distributed to the other industrial trucks in this preferred embodiment directly between the mobile radio stations, and not just by the stationary radio stations.

In another embodiment, the stationary radio stations are configured to determine current positions of industrial trucks from the received position-determining signals. The current positions of the industrial trucks determined in this manner are then forwarded to the other industrial trucks in the position signals.

### BRIEF DESCRIPTION OF THE DRAWINGS

Preferred embodiments of the invention are explained in greater detail below. In the following:

FIG. 1 illustrates a schematic view of two embodiments of an industrial truck, each with a different link to their mobile radio units, as well as three embodiments of stationary radio stations; and

FIG. 2 illustrates a top plan view of a warehouse with three embodiments of the stationary radio stations.

### DETAILED DESCRIPTION OF THE INVENTION

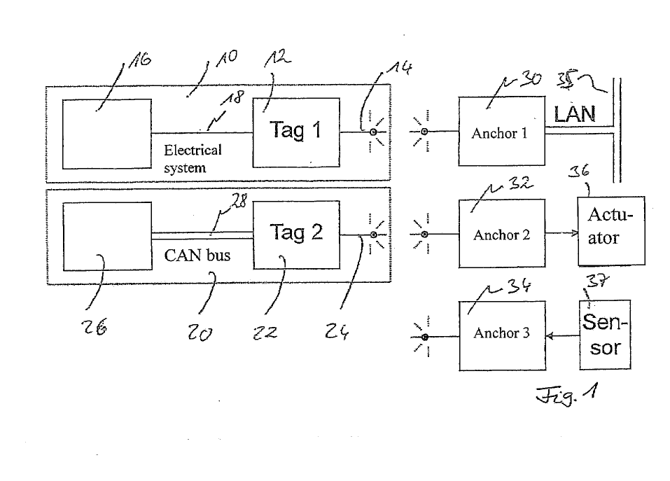

FIG. 1 shows a schematic view of an industrial truck 10 that comprises a mobile radio unit 12. The mobile radio unit 12 comprises an antenna 14. The mobile radio unit 12 and antenna 14 together form a mobile radio station. The industrial truck 10 comprises a vehicle control 16 that is connected to the mobile radio unit 12 via internal cabling.

Still referring to FIG. 1, another embodiment of the industrial truck 20 comprises a mobile radio unit 22 with an antenna 24. The vehicle control 26 is connected via a CAN bus 28 to the mobile radio unit 22.

The stationary radio stations 30, 32, 34 are also termed anchors. As shown in FIG. 1, the anchors 30, 32, 34 are arranged in a warehouse area fixed in space. Each of the anchors 30, 32, 34 comprises an antenna by which the radio signals can be transmitted and received. Referring to FIG. 1, the stationary radio station 30 is connected via a local network (LAN) to the other data processing in the warehouse, and can accordingly for example access the data of a warehouse management system.

As shown in FIG. 1, the stationary radio station 32 communicates with an actuator 36. The actuator 36 can be actuated by a corresponding control command from the vehicle via the stationary radio station 32. Accordingly, for example, an approaching industrial truck can trigger an opening of the warehouse door.

Still referring to FIG. 1, the stationary radio station 34 is connected to a sensor, which makes it possible to forward sensor values detected in the warehouse, such as brightness and temperature, to the industrial truck(s) in the warehouse.

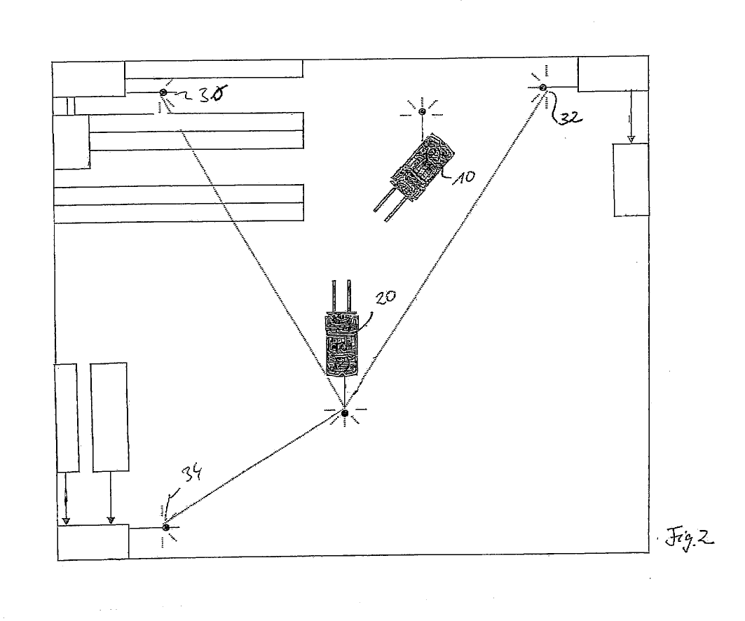

FIG. 2 shows a schematic view of radiolocating for the two industrial trucks 10 and 20. The industrial truck 20 has transmitted position-determining signals sequentially to the stationary radio stations 30, 32, 34 via its mobile radio station. The stationary radio stations 30, 32, 34 respond with a position signal after a predetermined time span. The distance to the stationary radio station can be determined from the time span that must be waited for the response, wherein the time span results from twice the propagation time and a predetermined processing time span for the stationary radio station 30, 32, 34. The position of the industrial truck 20 can be determined from the distance to at least three stationary radio stations 30, 32, 34. The position of the three stationary radio stations 30, 32, 34 in this case is known to the industrial truck 20.

Moreover, the vehicle speed and the steering angle position of the industrial truck are transmitted to the mobile radio station. The transmission is carried out either by the vehicle's own CAN bus 28 (FIG. 1), or via lines 18 (FIG. 1) provided therefor. These data are transmitted by the mobile radio station together with the current vehicle position to the stationary radio stations 30, 32, 34 so that they can be sent by them to all other mobile radio stations. Accordingly, the current position data and possibly the current vehicle data on the vehicle speed and steering angle as well can be provided to all industrial trucks so that they can always perform an effective collision control.

In the industrial truck, the determination of the position by radio is supplemented with the current data on the vehicle speed and steering angle by using the Kalman filter and processed into precise position information. In this context, not only the position of the individual vehicle is determined, but the position of the other vehicles can be determined as well. The other industrial trucks can also use a Kalman filter when the vehicle speed and/or the steering angle of the respective industrial truck are available.

The system for precise determination of position also has the advantage that signals can be generated for the behavior of the industrial truck in a position-dependent manner. For example, the vehicle speed can be reduced in areas in which many other industrial trucks are located and are moving. The position of the industrial truck can also be exchanged between each other or via the stationary radio stations 30, 32, 34, where movements are recognized, and the vehicle speed can be reduced if the density of vehicles is excessive.

It is also possible to perform a determination of the distance relative to other vehicles by measuring propagation time in this instance as with the stationary radio stations.

### REFERENCE NUMBER LIST

10 Industrial truck
12 Mobile radio unit
14 Antenna
16 Vehicle control
18 Wired connection
20 Industrial truck
22 Radio unit
24 Antenna
26 Vehicle control
28 CAN bus
30 Stationary radio station
32 Stationary radio station
34 Stationary radio station
35 LAN
36 Actuator

1. A method for determining a current position of at least one industrial truck having a mobile radio station and positioned in an area having a plurality of stationary radio stations, the method comprising:
determining vehicle data pertaining to at least one of a vehicle speed and a steering angle of the at least one industrial truck;
transmitting a position-determining signal from the mobile radio station to the plurality of stationary radio stations, the plurality of stationary radio stations receiving the position-determining signal from the mobile radio station;
transmitting a position signal from each of the plurality of the stationary radio stations to the mobile radio station in response to the received position-determining signal;
appending additional data to at least one of the position-determining signal and the position signal; and
determining the current position of the at least one industrial truck from at least three position signals received by the mobile radio station.

2. The method according to claim 1, wherein the additional data is vehicle data that is appended to the position-determining signal.

3. The method of claim 1, wherein the additional data is position data that is appended to the position signal.

4. The method according to claim 1, wherein the current position of the at least one industrial truck is determined using a Kalman filter.

5. The method according to claim 2, wherein the vehicle data also comprise the current position of the at least one industrial truck.

6. The method according to claim 1, wherein the mobile radio station is configured to determine a current position of other industrial trucks from position signals received by the mobile radio station.

7. The method according to claim 6, wherein information regarding the current position of other industrial trucks is received by mobile radio stations of each of the other industrial trucks.

8. The method according to claim 1, wherein the plurality of stationary radio stations are configured to determine current positions of other industrial trucks from position-determining signals received from mobile radio stations of each of the other industrial trucks.

9. The method according to claim 8, wherein the at least one industrial truck changes at least one of the vehicle speed and the steering angle in response to the determined current positions of the other industrial trucks when a collision hazard is indicated.

10. The method according to claim 1, further comprising a plurality of mobile radio stations configured to respond to a position-determining signal with a position signal so that an industrial truck transmitting the position-determining signal from its mobile radio station can determine its distance from other industrial trucks each transmitting a separate position signal from their respective mobile radio stations.

11. The method according to claim 1, wherein a control command from the at least one industrial truck can trigger one of a vehicle function and an external actuator.

12. A system for determining a position of at least one industrial truck in an area having a plurality of stationary radio stations, the system comprising:
a mobile radio station positioned on the at least one industrial truck that is configured to transmit a position-determining signal to the plurality of stationary radio stations and receive position signals from the plurality of stationary radio stations; and
an evaluation unit configured to append vehicle data to the position-determining signal transmitted to the plurality of stationary radio stations, and further configured to separate position data from other industrial trucks from position signals received from the plurality of stationary radio stations, wherein the evaluation unit determines a current position of the at least one industrial truck using at least three received position signals.

13. The system according to claim 12, wherein the vehicle data comprise at least one of a vehicle speed and a steering angle of the at least one industrial truck.

14. The system according to claim 12, wherein the vehicle data comprise a current vehicle position.

15. The system according to claim 12, wherein the evaluation unit is configured to determine a current position of other industrial trucks from a position signal received from each of the plurality of stationary radio stations.

16. The system according to claim 12, wherein the mobile radio station is further configured to receive signals pertaining to a current position of another industrial truck from other mobile radio stations.

17. The system according to claim 12, wherein the plurality of stationary radio stations are configured to determine current positions of multiple industrial trucks from position-determining signals received from the mobile radio stations of each of the multiple industrial trucks.

18. A system for determining a position of at least one industrial truck in relation to other industrial trucks in an area, the system comprising:
a plurality of mobile radio stations that are each positioned on an industrial truck, the plurality of mobile radio stations each configured to transmit a position-determining signal; and
a plurality of stationary radio stations configured to receive the position-determining signal from each of the plurality of mobile radio stations and transmit a position signal to each of the plurality of mobile radio stations, wherein the at least one industrial truck receiving the position signal can determine its distance relative to the other industrial trucks and evaluate whether a collision hazard exists.
